(19) United States
(12) Patent Application Publication
(10) Pub. No.: US 2025/0377946 A1
(43) Pub. Date: Dec. 11, 2025

(54) SCHEDULE RECOMMENDATION IN FINOPS GOVERNANCE WITH A MULTI-CLOUD GOVERNANCE PLATFORM

(71) Applicants: SABAPATHY ARUMUGAM, seattle, CA (US); KAMALA KANNAN SOMASUNDARM, chennai (IN); HEM CHANDRA PADHALNI, chennai (IN)

(72) Inventors: SABAPATHY ARUMUGAM, seattle, CA (US); KAMALA KANNAN SOMASUNDARM, chennai (IN); HEM CHANDRA PADHALNI, chennai (IN)

(21) Appl. No.: 19/220,055

(22) Filed: May 27, 2025

Related U.S. Application Data
(60) Provisional application No. 63/651,935, filed on May 24, 2024.

(51) Int. Cl. G06F 9/50

(52) U.S. Cl. CPC G06F 9/5027

(57) ABSTRACT

A computer-implemented method for schedule recommendation in FinOps governance with a multi-cloud governance platform involves collecting utilization data from cloud resources across multiple providers through APIs, including CPU, memory, and network metrics. The computing system normalizes this data by removing duplicates, adding time-based columns, and filtering incomplete sets. The system analyzes normalized data using predefined idle and high utilization thresholds, executing scoring algorithms that assign numerical scores based on resource utilization. Machine learning algorithms process historical patterns to generate hourly and weekly schedule recommendations for optimal resource stop and start times. The system presents recommendations through visual displays showing scheduling actions and cost savings, calculates potential cost reductions by multiplying pricing data with downtime periods, and automatically implements recommendations by transmitting control commands through cloud provider APIs to achieve the calculated cost reductions.

### CLAIM OF PRIORITY

This application claims priority to U.S. Patent Application No. 63/651,935, filed on May 24, 2024. The provisional application is hereby incorporated by reference in its entirety.

### BACKGROUND

A multi-cloud platform can have multiple accounts with respect to FinOps across various cloud providers. These accounts can be handed over to various teams. Accordingly, assessments may need to be made to account performance. For example, an account may be lacking with respect to cost optimization. In another example, an account may not be scheduled to run. Another example may be an account that may have too many orphans. Accordingly, improvements to multi-cloud platform governance that provide FinOps governance maturity assessments of the plurality of accounts are desired so that account managers can take appropriate actions.

In cloud computing, costs for resources, particularly virtual machines, or instances, are incurred only when they're in use. By implementing a strategy where these resources are halted when not actively utilized and restarted as needed, one can effectively optimize resource consumption, resulting in significant cost reductions.

However, cloud providers typically do not offer straightforward methods for distinguishing between idle and active resources at any given time. This necessitates extensive analysis of historical data across various metrics such as CPU utilization, memory usage, and network activity to determine the status of a resource.

Once idle resources are identified, additional automation is necessary to manage their start and stop actions based on usage patterns. Moreover, this analysis must be conducted at regular intervals to consistently identify idle and active states based on resource usage patterns.

### SUMMARY OF THE INVENTION

A computer-implemented method for schedule recommendation in FinOps governance with a multi-cloud governance platform involves several integrated technical processes executed by a computing system. The method begins by collecting utilization data from a plurality of cloud resources across multiple cloud service providers through application programming interfaces, where the utilization data comprises CPU utilization metrics, memory utilization metrics, and network utilization metrics for each cloud resource of the plurality of cloud resources. The computing system then normalizes the utilization data by executing data processing operations comprising removing duplicates, adding derived time-based columns comprising date, datetime, hour, and day of week, and filtering incomplete data sets to generate normalized utilization data. Subsequently, the computing system analyzes the normalized utilization data using predefined thresholds to generate utilization scores for each cloud resource, wherein the predefined thresholds comprise idle thresholds and high utilization thresholds, and wherein analyzing comprises executing scoring algorithms that assign numerical scores based on resource utilization relative to the predefined thresholds. The computing system generates schedule recommendations based on the utilization scores by executing machine learning algorithms that process historical utilization patterns to identify optimal stop and start times, wherein the schedule recommendations comprise hourly recommendations for stopping cloud resources during specific hours and weekly recommendations for stopping cloud resources during specific days of the week. The computing system presents the schedule recommendations to a user interface for review and implementation by rendering visual displays of recommended scheduling actions and associated cost savings. Additionally, the computing system calculates potential cost reductions by executing cost analysis algorithms that multiply resource pricing data with recommended downtime periods. Finally, the computing system automatically implements the schedule recommendations by transmitting stop and start commands through cloud service provider APIs to control the plurality of cloud resources according to the schedule recommendations, thereby achieving the calculated cost reductions.

### BRIEF DESCRIPTION OF THE DRAWINGS

FIG. 1 illustrates an example process for providing FinOps governance maturity assessment, according to some embodiments.

FIG. 2 illustrates an example process for providing strategies to optimize resource utilization, according to some embodiments.

FIG. 3 illustrates an example process to establish and iterate actions for efficient governance with a for multi-cloud platform, according to some embodiments.

FIG. 4 illustrates another example process for FinOps Governance Maturity Assessment, according to some embodiments.

FIG. 5 illustrates an example system, according to some embodiments.

FIG. 6 illustrates an example for providing cost-spend visibility and/or cost optimization recommendations into FinOps governance maturity assessment reports, according to some embodiments.

FIG. 7 illustrates an example process for scheduling recommendations in FinOps governance with a multi-cloud governance platform, according to some embodiments.

FIG. 8 illustrates an example system for schedule recommendation in FinOps governance with a multi-cloud governance platform, according to some embodiments.

FIG. 9 illustrates an example process for automation of FinOps recommendations, according to some embodiments.

FIG. 10 illustrates an example system for implementing scheduling recommendation, according to some embodiments.

The Figures described above are a representative set and are not an exhaustive with respect to embodying the invention.

### DESCRIPTION

Disclosed are a system, method, and article of manufacture for schedule recommendation in FinOps governance with a multi-cloud governance platform. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to ‘one embodiment,’ ‘an embodiment,’ ‘one example,’ or similar language means that a particular feature, structure, or characteristic described in connection with the embodiment is included in at least one embodiment, according to some embodiments. Thus, appearances of the phrases ‘in one embodiment,’ ‘in an embodiment,’ and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

### Definitions

Example definitions for some embodiments are now provided.

Amazon Web Services, Inc. (AWS) is an on-demand cloud computing platform(s) and API( )s. These cloud-computing web services can provide distributed computing processing capacity and software tools via AWS server farms. AWS can provide a virtual cluster of computers, available all the time, through the Internet. The virtual computers can emulate most of the attributes of a real computer, including hardware central processing units (CPUs) and graphics processing units (GPUs) for processing; local/RAM memory; hard-disk/SSD storage; a choice of operating systems; networking; and pre-loaded application software such as web servers, databases, and customer relationship management (CRM).

Microsoft Azure (e.g. Azure as used herein) is a cloud computing service operated by Microsoft for application management via Microsoft-managed data centers. It provides software as a service (Saas), platform as a service (PaaS) and infrastructure as a service (IaaS) and supports many different programming languages, tools, and frameworks, including both Microsoft-specific and third-party software and systems.

Cloud computing architecture refers to the components and subcomponents required for cloud computing. These components typically consist of a front-end platform (fat client, thin client, mobile), back-end platforms (servers, storage), a cloud-based delivery, and a network (Internet, Intranet, Intercloud). Combined, these components can make up cloud computing architecture. Cloud computing architectures and/or platforms can be referred to as the ‘cloud’ herein as well.

Cloud resource model (CRM) provides ability to define resource characteristics, Hierarchy, dependencies, and its action in a declarative model and embed them in Open API specification. CRM allows both humans and computers to understand and discover capabilities and characteristics of cloud service and its resources.

Containerization is operating system-level virtualization or application-level virtualization over multiple network resources so that software applications can run in isolated user spaces called containers in any cloud or non-cloud environment, regardless of type or vendor. Containers can be fully functional and portable cloud or non-cloud computing environment surrounding the application and keeping it independent of other parallelly running environments. Individually each container simulates a different software application and runs isolated processes by bundling related configuration files, libraries and dependencies. Multiple containers can share a common operating system kernel (OS). Containerization has been adopted by cloud computing platforms like, inter alia: Amazon Web Services, Microsoft Azure, Google Cloud Platform, and IBM Cloud.

Hyperscalers can be large cloud service providers. Hyperscalers can be the owners and operators of data centers where these horizontally linked servers are housed.

Multi-cloud refers to a company utilizing multiple cloud computing services from various public vendors within a single, heterogeneous architecture. This approach can enhance cloud infrastructure capabilities and optimizes costs. It can also refer to the distribution of cloud assets, software, applications, etc. across several cloud-hosting environments.

### Example Systems and Methods

A multi-cloud governance platform is provided that empowers enterprises to rapidly achieve autonomous and continuous cloud governance and compliance at scale. Multi-cloud governance platform is delivered to end users in the form of multiple product offerings, bundled for a specific set of cloud governance pillars based on the client's needs. Example multi-cloud governance platform's offerings and associated cloud governance pillars are now discussed.

The multi-cloud governance platform can provide FinOps as a solution offering that is designed to help an entity develop a culture of financial accountability and realize the benefits of the cloud faster. The multi-cloud governance platform SecOps as a solution offering designed to help keep cloud assets secure and compliant. The multi-cloud governance platform is a solution offering designed to help optimize cloud operations and cost management in order to provide accessibility, availability, flexibility, and efficiency while also boosting business agility and outcomes. The multi-cloud governance platform provides a Well-Architected Assessment functionality (e.g. CoreStack Assessments®, etc.) that is designed to help an entity adopt best practices according to well-architected frameworks, gain continuous visibility, and manage risk of cloud workloads with assessments, policies, and reports that allow an administrator to review the state of applications and get a clear understanding of risk trends over time.

Well-Architected Assessment functionality helps enterprises adopt cloud best practices, manage risk, and maintain reliable, secure, resilient, cost-efficient, performant, and sustainable cloud infrastructures.

Cloud Governance Pillars that can be implemented by the multi-cloud governance platform are now discussed. The multi-cloud governance platform can enable governing of cloud assets involves cost-efficient and effective management of resources in a cloud environment while adhering to security and compliance standards. There are several factors that can be involved in a successful implementation of cloud governance. The multi-cloud governance platform has encompassed all these factors into its cloud governance pillars. The following table explains the key cloud governance pillars developed by Multi-cloud governance platform.

Cloud trail (e.g. using AWS CloudTrail as an example) can be a service that helps enable operational and risk auditing, governance, and compliance of an AWS account. Actions taken by a user, role, or an AWS service are recorded as events in the cloud trail service. Events can include various actions taken, inter alia in the: AWS Management Console, AWS Command Line Interface, and AWS SDKs and APIs.

The multi-cloud governance platform utilizes various operations that provide the capability to operate and manage various cloud resources efficiently and effectively using various features such as automation, monitoring, notifications, activity tracking.

The multi-cloud governance platform utilizes various security operations that enable management of the security governance of various cloud accounts and identify the security vulnerabilities and threats and resolve them.

The multi-cloud governance platform utilizes various manages cost. The multi-cloud governance platform enables users to create a customized controlling mechanism that can control a customer's cloud expenses within budget and reduce cloud waste by continually discovering and eliminating inefficient resources.

The multi-cloud governance platform utilizes various access operations. The multi-cloud governance platform utilizes various allows administrators to configure secure access of resources in a cloud environment and protect the users' data and assets from unauthorized access.

The multi-cloud governance platform utilizes various resource management operations. The multi-cloud governance platform enables users to define, enforce, and track the resource naming and tagging standards, sizing, and their usage by region. It also enables a customer to follow consistent and standard practices pertaining to resource deployment, management, and reporting.

The multi-cloud governance platform utilizes various compliance actions. The multi-cloud governance platform guides users to assess a cloud environment for its compliance status against standards and regulations that are relevant to an organization—ISO, NIST, HIPAA, PCI, CIS, FedRAMP, AWS Well-Architected framework, and custom standards.

The multi-cloud governance platform utilizes various self-service operations. The multi-cloud governance platform enables administrators to configure a simplified self-service cloud consumption model for end users that are tied to approval workflows. It enables an entity to automate repetitive tasks and focus on key deliverables.

The multi-cloud governance platform continuously assesses the state of the customer's cloud workloads against well-architected frameworks to manage risk and embrace best practices. These best practices can be provided across certain ‘pillars’ (e.g. cost, security, operations, security, sustainability, etc.). The multi-cloud governance platform includes a Well-Architected Assessment functionality that designed to help adopt best practices, gain continuous visibility, and manage risk for cloud workloads with assessments, policies, and reports that allow a customer to review the state of a customer's applications and get a clear understanding of risk trends over time. Further, it automatically discovers issues and provides actionable insights for remediation, simplifying and streamlining the process of assessing, improving, and maintaining cloud workloads. The multi-cloud governance platform can onboard cloud accounts and manage workloads. In this way, the multi-cloud governance platform supports well-architected frameworks (WAF).

The Well-Architected Assessment functionality helps ensure user workloads are optimized as part of a strong cloud strategy in the following key areas: automate discovery and remediate at scale discovering issues across best practice areas for user cloud workloads can be difficult and time-consuming, which is why the multi-cloud governance platform implements auto-discovery and remediation features. This helps improve user productivity for detecting any issues in a cloud account or workloads and provides those insights for a user to look into and remediate at scale. The Well-Architected Assessment functionality can enable collaboration with multiple teams and enable gathering information and collecting evidence for best practices can present challenges around collaboration. Since it's usually not a single person doing the assessment, but a group of people across different teams, the multi-cloud governance platform provides built-in collaboration features to make assessing user workloads easier. The Well-Architected Assessment functionality can be used to validate across multi-cloud workloads. The multi-cloud governance platform helps make it possible to validate best practices across multiple clouds by providing a single pane of glass to do a well-architected review across diverse workloads. The multi-cloud governance platform also supports a multi-cloud well architected framework for workloads that span across more than one cloud provider. The Well-Architected Assessment functionality can classify best practices. Cloud best practices can fall into multiple categories. As part of the Well-Architected Assessment functionality, the multi-cloud governance platform provides built-in pillars respective to each cloud platform (AWS, Azure, etc.) that organize best practices into relevant areas of focus, such as operations, security, sustainability, and more. The multi-cloud governance platform include these pillars to helps users clearly define which areas they need to focus on and guide a user in terms of next steps to move towards a well-architected cloud infrastructure.

The Well-Architected Assessment functionality can enable map policies to workloads best practices for different cloud platforms are reinforced in the multi-cloud governance platform by built-in policies, which are mapped directly to various best practices. These policies help identify any violations in a workload based on a particular best practice. Policies come pre-loaded and pre-mapped, but a user can also create and map a customer's policies. This enables a user to validate user workloads against best practices with more ease and control. Automate best practices even with built in best practice classification and policies, validating user workloads against best well-architected frameworks can still require manual work.

The multi-cloud governance platform the Well-Architected Assessment functionality maps relevant policies to identify violations against certain best practice and can automate most of the work needed to validate user workloads and identify any violations, reducing the amount of overhead and effort needed on a user. Built-in suggestions for remediation can be provided. For many of The multi-cloud governance platform's automated policies, any identified violations that appear as part of an assessment will come with a suggested remediation to address it. These suggestions appear directly to the user in the multi-cloud governance platform web portal, making it easy to both find and fix any issues with user cloud workloads.

Built-in evidence tracking is provided. The multi-cloud governance platform can keep track of what steps were taken to implement best practices and address any violations is a key part of the cloud optimization process. The multi-cloud governance platform the Well-Architected Assessment functionality can simplify and streamline this part of the process by providing built-in comment and file attachment features for each best practice item included in an assessment. Users can add evidence directly in the assessment to show what was done to meet certain best practices, as well as create a milestone once an assessment is complete to log a snapshot of a workload that can be referenced later.

Clear assessment workflow is implemented by the multi-cloud governance platform. Progress through assessments with ease with a built-in workflow that helps the user to follow each step of the assessment process and account for each best practice item along the way. The multi-cloud governance platform can start an assessment, go through the questions, remediate any violations it finds, then reach a finishing point where an administrator is ready to create a milestone. Export assessment reports In addition to being able to monitor user assessment results directly in the multi-cloud governance platform web portal, results can be exported as reports (e.g. PDF or image file). This makes it easy to share the results of an assessment with other members of a team, or across departments.

The multi-cloud governance platform can integrate with AWS Well-Architected (WA). The multi-cloud governance platform the Well-Architected Assessment functionality supports one-directional integration with AWS Well-Architected, meaning it can send data directly from The multi-cloud governance platform to AWS. When a user completes an assessment, whatever best practices the user provides answers can be synced to AWS so that results show there as well. This is helpful for keeping information consistent across both The multi-cloud governance platform and AWS environments. The multi-cloud governance platform's mission is to not only help with assessing cloud posture, but to provide a clear path to realizing well-architected workloads.

### FinOps Governance Maturity Assessment

FinOps focuses on driving financial accountability for all stakeholders across finance, product, and procurement teams to get the benefits of both agile development and forecast-able cloud consumption. Adopting FinOps in a multi-cloud governance platform allows organizations to ensure they are achieving the most efficient use of their cloud consumption through repeatable processes, unified key performance indicators (KPIs), and the ability to understand the business value of their cloud spend through unit economics. A multi-cloud governance platform FinOps solution offers can be designed to help administrators to develop a culture of financial accountability and realize the benefits of the cloud faster. It accomplishes this through a set of features, tools, and capabilities that enable you to improve predictability, prevent budget overruns, and make more data-driven business decisions. Some key features and benefits of multi-cloud governance platform FinOps include, inter alia: granular visibility and insights into resource utilization and costs. Multi-cloud governance platform FinOps can provide action-oriented, multi-cloud, multi-dimensional reports including daily/monthly cost view, consolidated charges, charge-back reports, and more. multi-cloud governance platform FinOps can provide end-to-end workflow integration with IT service management (ITSM) tools (e.g. ServiceNow, Jira, etc.).

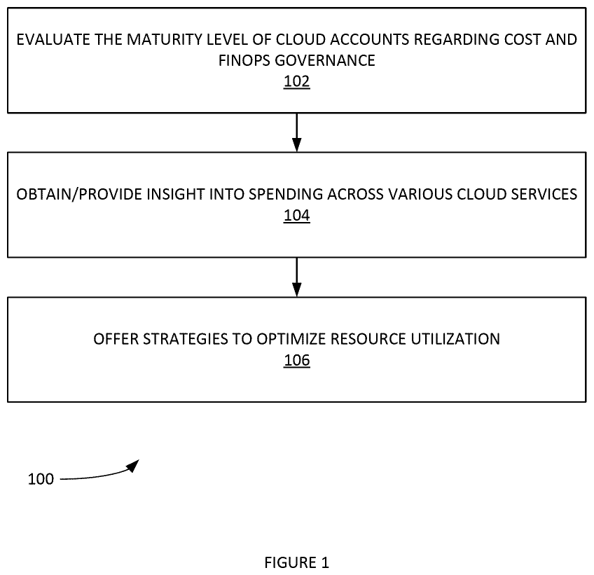

FIG. 1 illustrates an example process 100 for providing FinOps governance maturity assessment, according to some embodiments. It is noted that cloud governance involves establishing policies, procedures, and controls to effectively manage and enhance the utilization of cloud resources within an organization.

In step 102, process 100 evaluates the maturity level of cloud accounts regarding cost and FinOps governance. This assessment is centered around optimizing cloud expenditure through the monitoring of resource consumption, identification of cost-saving opportunities, and implementation of budgetary constraints.

In step 104, process 100 obtains/provides insight into spending across various cloud services. In step 106, based on the output of step 104, process 100 can offer strategies to optimize resource utilization. These insights can be obtained by process 200.

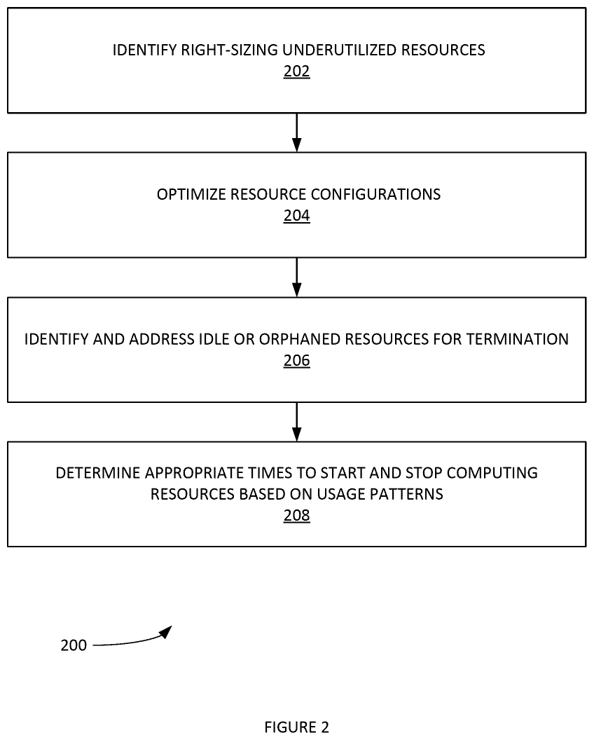

FIG. 2 illustrates an example process 200 for providing strategies to optimize resource utilization, according to some embodiments. In step 202, process 200 can identify right-sizing underutilized resources. In step 204, process 200 can optimize resource configurations. In step 206, process 200 can identify and address idle or orphaned resources for termination. In step 208, process 200 can determine the appropriate times to start and stop computing resources based on usage patterns.

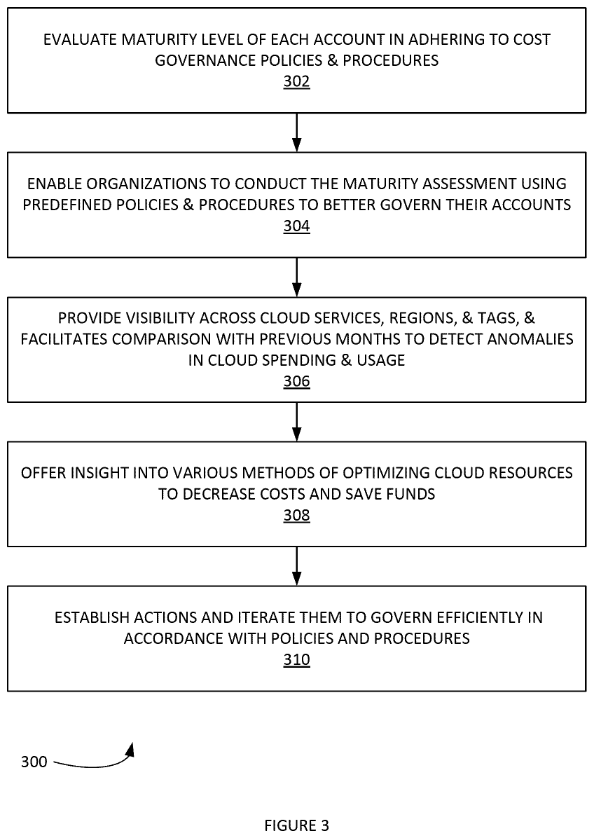

FIG. 3 illustrates an example process 300 to establish and iterate actions for efficient governance with a for multi-cloud governance platform, according to some embodiments. It is noted that each organization/entity can operate multiple cloud accounts. Each of the multiple cloud accounts can be managed and utilized by different teams as well. Consequently, cloud governance concerning cost and FinOps may vary from one account to another and from team to team. The FinOps Governance Maturity Assessment provided herein can evaluate the maturity level of each account in adhering to cost governance policies and procedures 302. This can enable teams to act upon recommendations and enhance their maturity score.

In step 304, process 300 can enable organizations to conduct the maturity assessment using predefined policies and procedures to better govern their accounts. This assessment provides visibility across cloud services, regions, and tags, and thus, facilitates comparison with previous months to detect anomalies in cloud spending and usage in step 306. In step 308, process 300 can offer insight into various methods of optimizing cloud resources to decrease costs and save funds. By comparing the maturity levels of different cloud accounts, organizations can establish actions and iterate them to govern efficiently in accordance with policies and procedures in step 310.

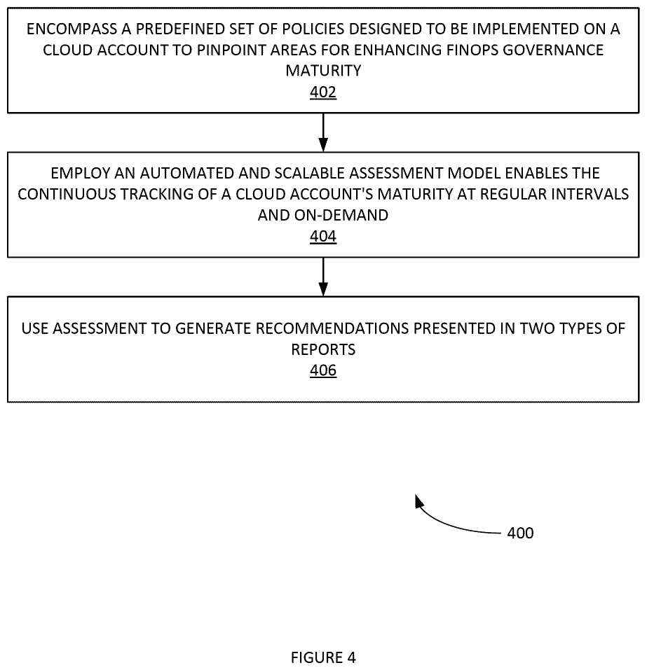

FIG. 4 illustrates another example process 400 for FinOps Governance Maturity Assessment, according to some embodiments. In step 402, process 400 encompasses a predefined set of policies designed to be implemented on a cloud account to pinpoint areas for enhancing FinOps governance maturity.

In step 404, process 400 employs an automated and scalable assessment model enables the continuous tracking of a cloud account's maturity at regular intervals and on-demand. In step 406, process 400 uses the assessment to generate recommendations presented in two types of reports. The first type of report is the Executive Summary Report. This report delivers a concise overview of visibility, recommendations, and operational guidelines for managing a cloud account effectively.

The second type of report is the detailed recommendation report. This report furnishes detailed insights at the level of cloud services and policies. It includes a list of resources that could benefit from optimization, such as right-sizing, configuration enhancements, identification of idle or orphaned resources, and scheduling recommendations. Additionally, it outlines the potential cost savings achievable by implementing these recommendations.

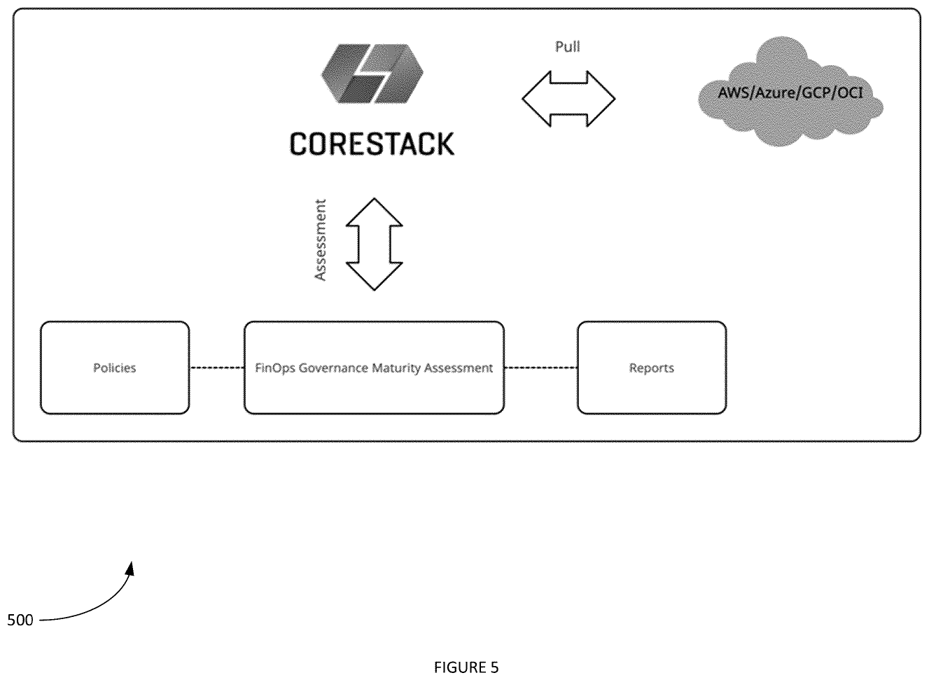

FIG. 5 illustrates an example system 500, according to some embodiments. System 500 can offer a diverse range of cost optimization suggestions sourced from both cloud providers and the multi-cloud governance platform. This can be accompanied by a maturity score for assessment and the capability to compare scores with past evaluations. The governance maturity assessment provides a summary tailored for CXOs, while delivering a detailed report aimed at procurement, engineering, and FinOps teams within the organization.

The multi-cloud governance platform policies extend coverage across cloud services, surpassing the recommendations typically offered by cloud providers. Adhering to FinOps best practices as defined by FinOps.org, the approach encompasses various facets of informing, optimizing, and operating for continual governance and enhancement.

More specifically, the multi-cloud governance platform (e.g. Corestack, etc.) can pull specified information available hyperscalers. This can include resources utilized by the applications, application utilizations, budgets, cost usage reports, other billing information, inventory discovery of client accounts, etc. These can be combined, and an assessment is the performed on the pulled data.

System 500 can generate a FinOps governance maturity assessment. In this way, system 500 can be used for FinOps governance mature assessment. The assessment analyses how a cloud account is performing with respect to informing/optimizing/operating cost. The output can be viewed in the form of a report where it provides insights and visibility on each of these three aspects. System 500 can assess various onboarded cloud accounts periodically to identify any violations and generate a FinOps Maturity Assessment Report. This assessment is performed against specific assessment scenarios, each having its own definition and weight. The assessment analyzes how each cloud account is performing with respect to controlling costs. Cost control identifies whether resources are managed within defined budget thresholds. Cost optimization checks if any resources are used in an optimized manner. The assessment also includes details around recommendations and cost avoidance. Based on the number of violated resources per scenario, a maturity index is derived. This maturity index helps an administrator understand how a cloud account is performing over a set time period.

A cloud account can be configured with the required privileges prior to onboarding the cloud account in order to perform a FinOps Maturity Assessment. Read-only access to most services can be sufficient for the FinOps Maturity Assessment in some examples.

System 500 provides a comprehensive FinOps Maturity Assessment Report for cloud accounts. A customer can view the assessment score for their cloud account that is identified based on the resources assessed. Cost avoidance is estimated for each of the assessment categories in a cloud account.

Cloud administrators can perform an assessment of their cloud accounts to view the governance index and compare them against each other to see where they stand according to others in industry benchmarks. An administrator can generate an automated assessment report every month to visualize the improvements/decline in the index.

$$Score = ( ( 100 - \% of Potential Cost Savings ) 0.5 ) + ( ( 100 - \% of Violated Resources ) 0.1 ) + ( ( 100 - \% of Budget Violations ) 0.2 ) + ( ( 100 - \% of Untagged Resources ) 0.2 ) \\ \% Of Potential Cost Savings = ( ( Potential Cost Savings ) / Average Monthly Cost ) * 100 ) . \\ \% Of Violated Resources = ( Total Violated Resources / Total Resources Assessed ) * 100 \\ \% Of Budget Violations = ( Total Violated Budget Scenarios / Total Budget Scenarios Assessed ) * 100$$

System 500 can provide a defined set of assessment scenarios based on a cloud platform, cloud services, and cloud resource types that are available in a cloud account. These assessment scenarios are based on Industry Standards and Best Practices, including those recommended by AWS, Azure, and GCP. There are scenarios available for each Governance Pillar: Operations, Security, Cost, Access, and Resource Consistency.

System 500 checks the status of a cloud environments against these standards for each of the 5 pillars and provides a consolidated report that covers multiple aspects of various cloud accounts. For example, an Operations assessment will include checks for multiple aspects such as Monitoring, Utilization, Activities, Automation, Backup, Patching, etc. Similarly, each pillar will have all their key areas covered as part of the assessment.

System 500 checks for the compliance percentage across various resources for each assessment scenario. Each scenario carries a certain weight based on how critical that is. An Assessment Score is provided for a cloud account by calculating the weighted average of the results across all scenarios.

System 500 can also schedule recommendations. These can be cost saving recommendations focusing on when a resource can be stopped by identifying when they are idle whether it is a specific hours in a day or specific day in a week. These recommendations are generated based on utilization metrics using ML algorithms. System 500 can perform a resource view of cost optimization recommendations. Example types of recommendations can include, inter alia: Right Sizing, Idle, Orphaned, Configuration, Schedule Recommendations, etc. for a resource and providing a visibility to the user to decide.

System 500 can provide cost usage reports. An administrator can select the required cloud account and view its report(s).

System 500 can provide Assessment Reports. Assessment reports can provide a detailed FinOps Maturity Assessment Report for specific Governance Pillars and Cloud Accounts. The report summary provides information about each assessment scenario for the selected cloud account, as well as an overall score for the account and the Governance Pillar. This helps to understand the specific areas where the account requires improvements and recommend any necessary next steps. The fields available in the Assessment Summary section are, inter alia: Assessment Sub-Category, Assessment Group, Assessment Scenario, Total Violated Resources, Total Resources Assessed, Potential Cost Avoidance, etc.

The report can be printed or exported in PDF and Excel file formats. While in the report, an administrator can switch between different Tenants, Cloud Accounts, and Assessment Dates to view the report and export one.

The Assessment Detail section provides a deeper view into the assessment results. An administrator can view the number of violated resources and total number of resources assessed for each of the assessment scenarios.

The fields available in the Assessment Detail section are, inter alia: Description, Resource Type/Resource, Total Resources Assessed, Number of Violated Resources, Total Estimated Monthly Cost Avoidance, Recommendations, etc.

The actual resources that are in violation are also listed after each Assessment Category. This helps the cloud administrator to identify the actual resources in violation so they can take immediate action to resolve them.

In one example, the FinOps Maturity Assessment Report contains the following sections:

FinOps Assessment: This section provides an overview of the FinOps maturity level of a cloud account;

FinOps Assessment Summary: This section summarizes the information identified for different FinOps assessment scenarios for a cloud account, and are grouped based on the categories;

FinOps Assessment Detail: This section provides further details for each resource involved in the FinOps Maturity Assessment and provides associated information to remediate any resource violations in a cloud account;

Cost Visibility: This section provides an overview of the actual costs incurred by resources against their forecasted costs;

Cost Insights: This section presents insights on various factors such as regions and tags that are available on a chosen cloud platform; and

Assessment Visibility: This section provides a summary of the resources that are involved in the assessment.

Visibility and Insights are captured as a snapshot and persist once the assessment is completed. This helps an administrator to relate cost avoidance, resources, and other details together. Point-in-time data for costs can be available only in the Posture and Other Cost Reports section.

Recommendations related to reservations are provided as part of the AWS management account that's consolidated for all the AWS member accounts. It is noted that some aspects of system 500 can be configurable to set thresholds for detecting various anomalies.

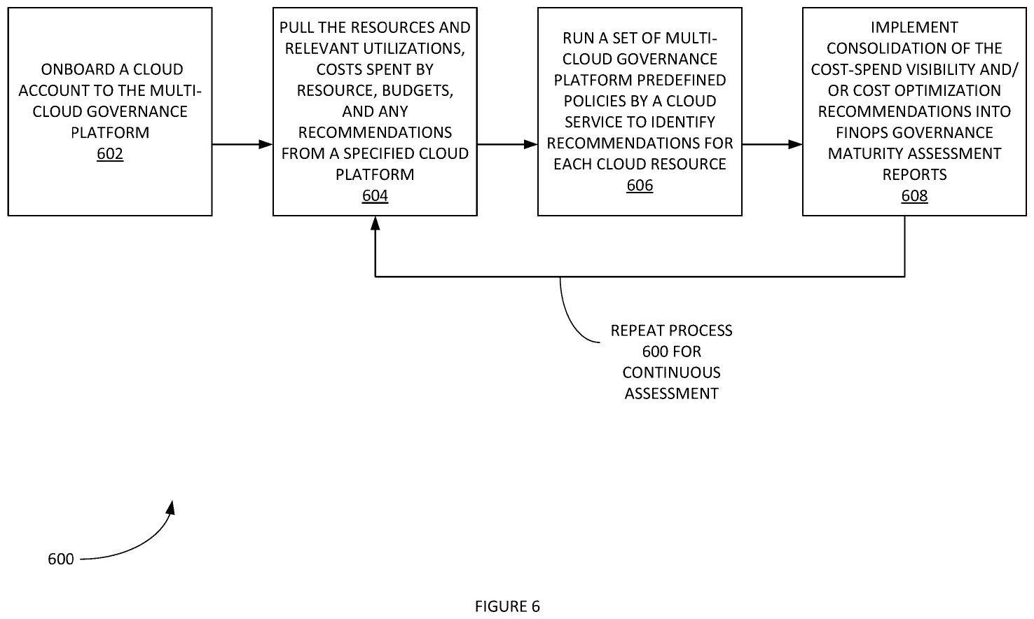

FIG. 6 illustrates an example for providing cost-spend visibility and/or cost optimization recommendations into FinOps governance maturity assessment reports, according to some embodiments. In step 602, process 600 can onboard a cloud account to the multi-cloud governance platform. In step 604, process 600 can pull the resources and relevant utilizations, costs spent by resource, budgets, and any recommendations from a specified cloud platform. In step 606, process 600 can run a set of multi-cloud governance platform predefined policies by a cloud service to identify recommendations for each cloud resource. In step 608, process 600 can implement consolidation of the cost-spend visibility and/or cost optimization recommendations into FinOps governance maturity assessment reports. These reports can be summaries and/or detailed.

### Schedule Recommendation in FinOps Governance With a Multi-Cloud Governance Platform

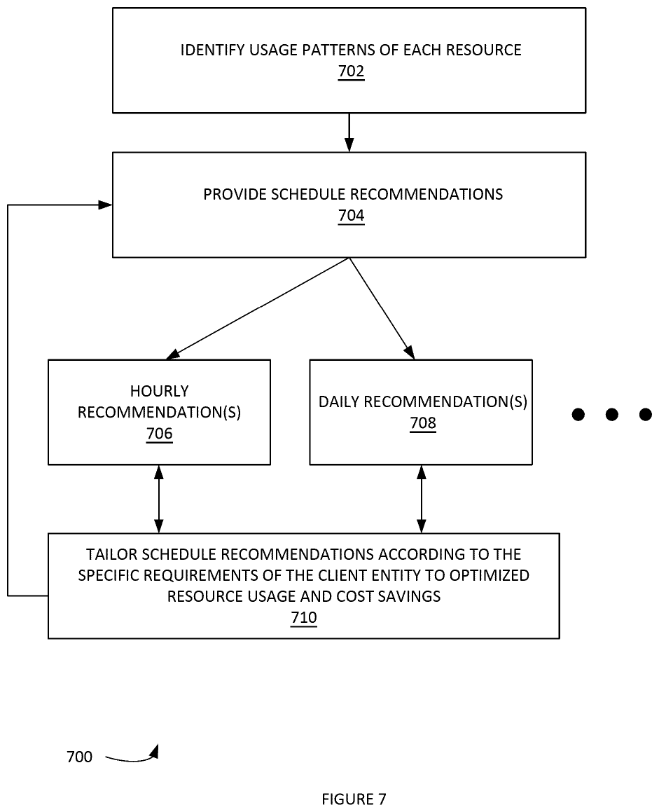

FIG. 7 illustrates an example process 700 for scheduling recommendations in FinOps governance with a multi-cloud governance platform, according to some embodiments. “Schedule Recommendations” offers a comprehensive solution to this challenge by leveraging AI/ML algorithms.

It is noted that development or testing workloads may remain active around the clock, yet they are actively utilized for only about a lesser percent (e.g. forty percent (40%) of the total running time. Some workloads are only necessary during business hours (e.g. 9 am to 6 pm, etc.) while others may be required to run only on weekdays and not over weekends.

In step 702, process 700 identifies the usage patterns of each resource.

In step 704, process 700 offers schedule recommendations. In some examples, these can be two types of schedule recommendations. The first type of schedule recommendation can be an Hourly Recommendation 706. Hourly Recommendation 706 can cover resources that can be stopped during specific hours on all days. A second type of schedule recommendation can be Weekly Recommendations 708. Weekly Recommendations Resources 708 can be stopped for entire days on specific days of the week.

In step 710, the schedule recommendations provided by the multi-cloud governance platform are tailored and implemented according to the specific requirements of the client entity (e.g. a business, etc.) in order to optimize resource usage, cost savings, etc. Customizations can be provided to customer(s).

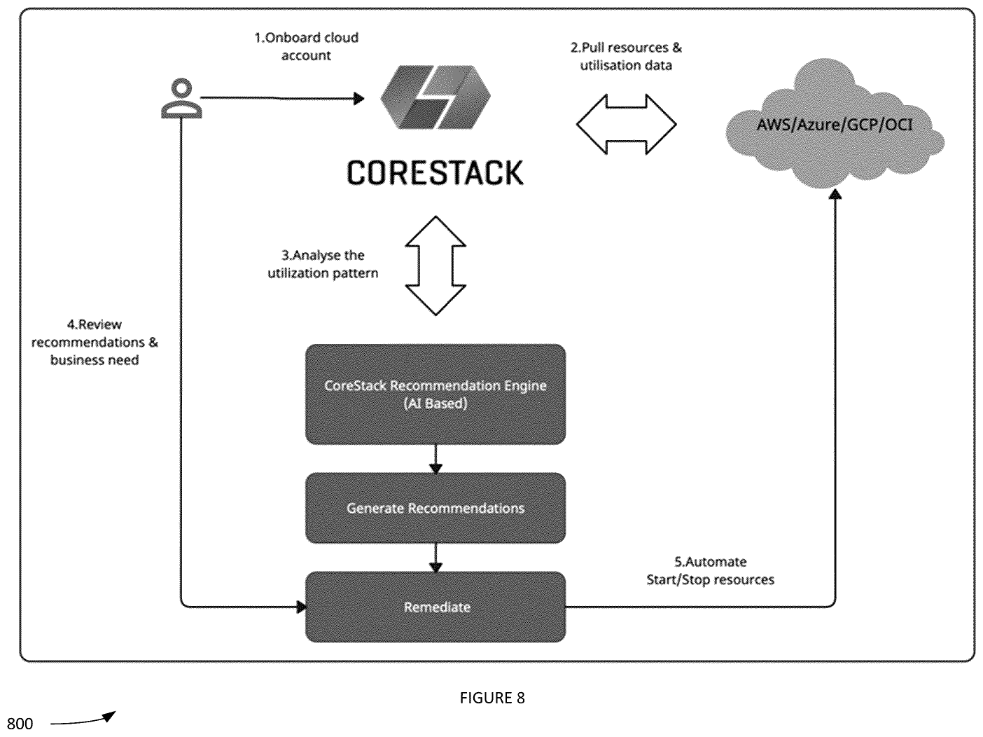

FIG. 8 illustrates an example system 800 for schedule recommendation in FinOps governance with a multi-cloud governance platform, according to some embodiments. System 800 can implement process 900.

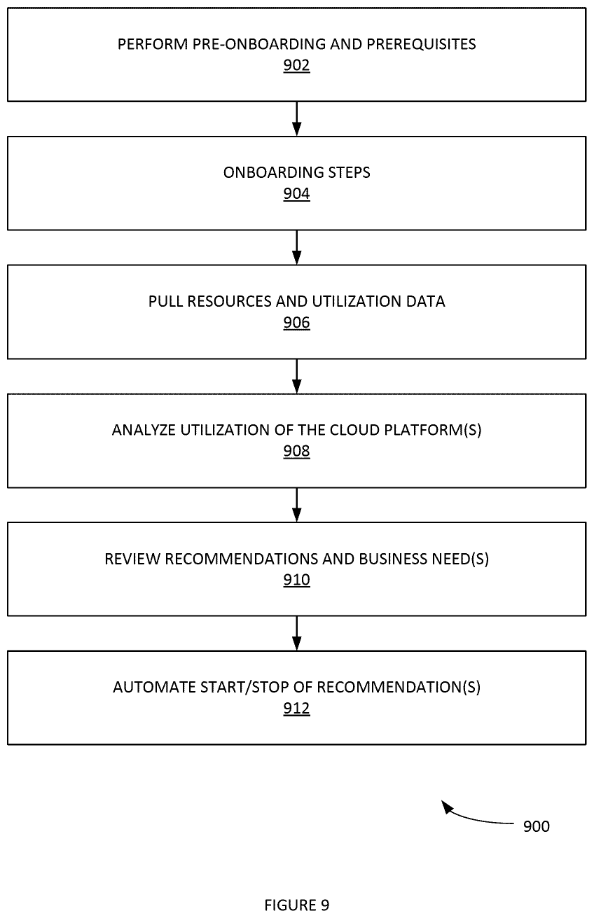

FIG. 9 illustrates an example process 900 for automation of FinOps recommendations, according to some embodiments. Process 900 can onboard one or more cloud accounts. In order to utilize the assessment feature available in the system 500, an administrator onboards one or more cloud accounts in a defined way to the multicloud governance platform. Here, an administrator can select the Assessment access type during the onboarding process and deploy the right template. The administrator can configure the cloud account after onboarding to enable access permissions.

The administrator (and/or other relevant entity) can perform pre-onboarding and prerequisites as well in step 902. Before process 900 can onboard any cloud accounts and run assessments on them, there are certain prerequisites that must be configured in those cloud accounts. The administrator can provide proper access permissions for the multicloud governance platform to setup in your cloud accounts first. This can be done for, inter alia: Amazon Web Services (AWS), Microsoft Azure, and Google Cloud Platform (GCP) cloud accounts.

For example, for the AWS prerequisites, the administrator can create an IAM Role for the multicloud governance platform with necessary access permissions for Assessment+Governance to be performed for that account. System 500 can provide ready-made templates that can be used for this purpose which have appropriate access permissions built-in as part of the templates.

In an Azure example, the prerequisites can have the administrator create an App Registration for the multicloud governance platform and then provide appropriate role assignment for that application for Assessment plus Governance to be performed for that subscription.

In a GCP prerequisites example and for GCP Projects, the administrator can create either a user account or service account for the multicloud governance platform and then provide appropriate roles for the user account or service account for Assessment plus Governance to be performed for that project.

Onboarding steps are performed in step 904. Once you set up the prerequisites in your cloud account and retrieve the required information from the cloud console, the administrator can initiate the onboarding process in the multicloud governance platform. It's a relatively straightforward process to onboard a cloud account into multicloud governance platform, provided the prerequisites are taken care of. The administrator can follow the simple in-app guided workflow for the onboarding process for the supported cloud accounts.

In step 902, process 900 performs pre-onboarding and prerequisites. Before process 900 can onboard any cloud accounts and run assessments on them, there are certain prerequisites that must be configured in those cloud accounts. The administrator can provide proper access permissions for the multicloud governance platform to setup in your cloud accounts first. This configuration involves creating appropriate IAM roles, service accounts, or application registrations depending on the cloud provider. The system validates these permissions to ensure sufficient access for both read-only monitoring operations and control operations for starting and stopping resources. Security protocols are established to maintain encrypted communication channels between the multi-cloud governance platform and each cloud provider's management APIs.

In step 906, process 900 can pull resources and utilization data. Utilization metrics (e.g. such as CPU, Memory, Network utilization data and any metric that can be useful to understand the utilization of the resource) from the cloud can be pulled into CoreStack from the cloud for each resource. This utilization data is maintained in CoreStack at hourly granularity allowing to understand the utilization pattern by each hour and roll up to each day/week/month to generate recommendations. The data collection process employs automated polling mechanisms that establish secure API connections with cloud monitoring services across multiple providers simultaneously. Real-time data validation ensures data integrity and completeness, while normalization algorithms standardize metrics across different cloud platforms to enable consistent analysis. The system maintains historical data retention policies and implements efficient data storage strategies to handle large volumes of time-series utilization data.

In step 908, process 900 can analyze utilization of the cloud platform(s). All public cloud platforms—AWS/Azure/GCP/OCI supported now. Any new public cloud can be added to the list as we integrate with CoreStack. Not only public cloud, process 900 can be used by any private cloud such as OpenStack, vCloud etc., to generate schedule recommendations. The analysis engine processes the collected utilization data through multiple algorithmic layers, including statistical analysis to identify baseline utilization patterns and anomaly detection algorithms to flag unusual resource behavior. Machine learning models are trained on historical data to recognize recurring usage patterns and predict optimal scheduling windows. The system calculates utilization scores using weighted algorithms that consider multiple metrics simultaneously, ensuring comprehensive resource assessment across heterogeneous cloud environments.

In step 910, process 900 can review recommendations and business need(s). By allowing the user to configure the below settings they can customize the recommendation, review the recommendations that suits their business needs and remediate them. The review process incorporates business logic validation to ensure recommendations align with operational requirements and compliance policies. Users can adjust threshold parameters through an intuitive configuration interface, allowing fine-tuning of recommendation sensitivity based on specific workload characteristics. The system provides impact assessment capabilities, showing potential cost savings alongside operational risk analysis for each recommendation. Interactive dashboards enable stakeholders to visualize recommendation outcomes and make informed decisions about implementation priorities.

In step 912, process 900 can automate start/stop of recommendation(s). Auto Remediation Settings to remediate recommendations automatically—resource with specific tags can be remediated automatically. The automation engine implements sophisticated scheduling algorithms that coordinate resource state changes across multiple cloud platforms while maintaining service dependencies and avoiding conflicts. Safety mechanisms include rollback capabilities, dependency checking, and exception handling to prevent unintended service disruptions. The system maintains detailed audit logs of all automated actions, including timestamps, resource identifiers, and operational outcomes for compliance and troubleshooting purposes. Integration with notification systems ensures stakeholders receive real-time updates about automated resource management activities and any exceptions that require manual intervention.

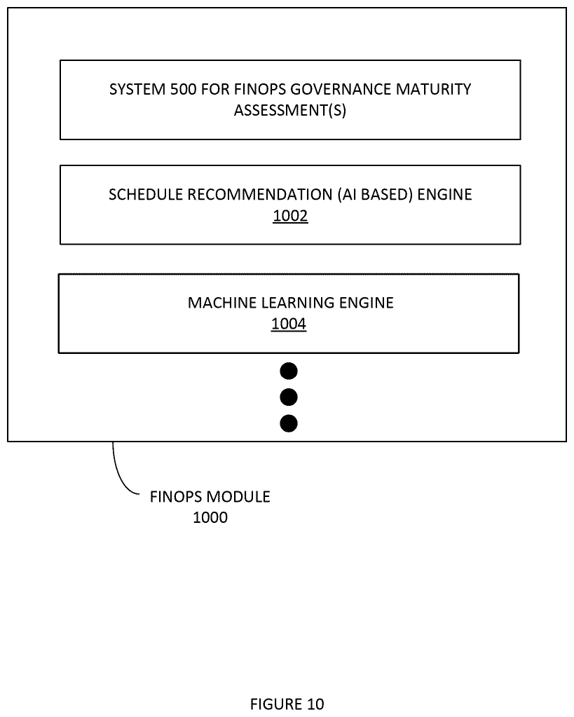

FIG. 10 illustrates an example system 1000 for implementing scheduling recommendation, according to some embodiments. Schedule Recommendation (AI Based) Engine 1002 relies on utilization data for each resource to analyze and generate recommendations. Upon onboarding a cloud account to a multi-cloud governance platform, utilization data is regularly pulled to the platform, either at regular intervals or in near-real time. Schedule Recommendation (AI Based) Engine 1002 then analyzes this data to generate both hourly and weekly schedule recommendations. Users can review these recommendations to align with their business requirements and automate resource start/stop actions by implementing the recommendations. Cost savings resulting from these optimized schedules are reflected in the cloud usage and billing information, which users can conveniently view within the multi-cloud governance platform.

Schedule Recommendation (AI Based) Engine 1002, which employs AI/ML algorithms to classify idle resources by identifying anomalies in utilization patterns (e.g. with ML engine 1004). This data is then converted into actionable recommendations. Users can view the potential cost savings (e.g. on a monthly basis, hourly basis, weekly basis, etc.) associated with each recommendation, enabling them to understand the cost impact of optimization efforts. Additionally, the solution offers an end-to-end workflow, starting from viewing utilization patterns to generating recommendations and finally implementing automated remediation actions. This seamless process ensures efficient resource management and cost optimization.

A machine learning engine 1004 can utilize machine learning algorithms to optimize the methods herein. Machine learning is a type of artificial intelligence (AI) that provides computers with the ability to learn without being explicitly programmed. Machine learning focuses on the development of computer programs that can teach themselves to grow and change when exposed to new data. Example machine learning techniques that can be used herein include, inter alia: decision tree learning, association rule learning, artificial neural networks, inductive logic programming, support vector machines, clustering, Bayesian networks, reinforcement learning, representation learning, similarity, and metric learning, and/or sparse dictionary learning. Random forests (RF) (e.g. random decision forests) are an ensemble learning method for classification, regression and other tasks, that operate by constructing a multitude of decision trees at training time and outputting the class that is the mode of the classes (e.g. classification) or mean prediction (e.g. regression) of the individual trees. RFs can correct for decision trees' habit of overfitting to their training set. Deep learning is a family of machine learning methods based on learning data representations. Learning can be supervised, semi-supervised or unsupervised.

Machine learning can be used to study and construct algorithms that can learn from and make predictions on data. These algorithms can work by making data-driven predictions or decisions, through building a mathematical model from input data. The data used to build the final model usually comes from multiple datasets. In particular, three data sets are commonly used in different stages of the creation of the model. The model is initially fit on a training dataset, that is a set of examples used to fit the parameters (e.g. weights of connections between neurons in artificial neural networks) of the model. The model (e.g. a neural net or a naive Bayes classifier) is trained on the training dataset using a supervised learning method (e.g. gradient descent or stochastic gradient descent). In practice, the training dataset often consist of pairs of an input vector (or scalar) and the corresponding output vector (or scalar), which is commonly denoted as the target (or label). The current model is run with the training dataset and produces a result, which is then compared with the target, for each input vector in the training dataset. Based on the result of the comparison and the specific learning algorithm being used, the parameters of the model are adjusted. The model fitting can include both variable selection and parameter estimation. Successively, the fitted model is used to predict the responses for the observations in a second dataset called the validation dataset. The validation dataset provides an unbiased evaluation of a model fit on the training dataset while tuning the model's hyperparameters (e.g. the number of hidden units in a neural network). Validation datasets can be used for regularization by early stopping: stop training when the error on the validation dataset increases, as this is a sign of overfitting to the training dataset. This procedure is complicated in practice by the fact that the validation dataset's error may fluctuate during training, producing multiple local minima. This complication has led to the creation of many ad-hoc rules for deciding when overfitting has truly begun. Finally, the test dataset is a dataset used to provide an unbiased evaluation of a final model fit on the training dataset. If the data in the test dataset has never been used in training (e.g. in cross-validation), the test dataset is also called a holdout dataset.

In one example, a k-nearest neighbors algorithm (k-NN) can be used. k-NN is a non-parametric supervised learning method. KNN can be used for classification and regression. In both cases, the input consists of the k closest training examples in a data set. The output depends on whether k-NN is used for classification or regression. In k-NN classification, the output is a class membership. An object is classified by a plurality vote of its neighbors, with the object being assigned to the class most common among its k nearest neighbors (e.g. k is a positive integer, typically small). If k=1, then the object is assigned to the class of that single nearest neighbor. In k-NN regression, the output is the property value for the object. This value is the average of the values of k nearest neighbors. If k=1, then the output is simply assigned to the value of that single nearest neighbor. k-NN is a type of classification where the function is only approximated locally, and all computation is deferred until function evaluation. Since this algorithm relies on distance for classification, if the features represent different physical units or come in vastly different scales then normalizing the training data can improve its accuracy dramatically.

It is noted that the ML engine 1004 can generate models at an entity level (e.g. a collection of applications of a customer with one or more specified hyperscalers, application level, etc.). The ML models can be based on client usage history, general usage history, etc. These datasets can be used to train and validate models.

### Enhanced Data Collection and Processing Architecture

The utilization data collection system should specify the use of RESTful APIs with OAuth 2.0 authentication protocols for secure communication with cloud service providers, implementing rate limiting and exponential backoff algorithms to handle API throttling. The system should employ distributed data collection nodes that can be deployed across multiple geographic regions to reduce latency and ensure high availability. Data normalization should utilize specific algorithms such as Z-score normalization for CPU metrics and Min-Max scaling for network throughput data, with time-series alignment using interpolation techniques like cubic spline or linear interpolation to handle missing data points. The system should implement a multi-tiered data storage architecture using time-series databases like InfluxDB or Apache Cassandra for raw metrics, with data compression algorithms such as Gorilla compression for efficient storage of repetitive time-series data.

### Advanced Machine Learning Pipeline Implementation

The machine learning algorithms should be specified as ensemble methods combining multiple techniques: Long Short-Term Memory (LSTM) neural networks for temporal pattern recognition, Isolation Forest algorithms for anomaly detection, and clustering algorithms like DBSCAN for resource usage pattern segmentation. The system should implement feature engineering pipelines that create rolling window statistics (7-day, 30-day moving averages), seasonal decomposition using methods like STL (Seasonal and Trend decomposition using Loess), and Fourier transform analysis to identify cyclical usage patterns. Model training should employ cross-validation with time-series splits to prevent data leakage, hyperparameter optimization using Bayesian optimization techniques, and automated model retraining pipelines triggered by concept drift detection algorithms that monitor prediction accuracy degradation over time.

### Sophisticated Scheduling and Automation Engine

The scheduling recommendation engine should implement constraint satisfaction algorithms that consider resource dependencies using directed acyclic graphs (DAGs) to prevent cascading failures when stopping interconnected resources. The system should employ genetic algorithms or simulated annealing for optimizing complex scheduling scenarios with multiple conflicting objectives (cost reduction vs. performance maintenance). Auto-remediation should utilize state machines with safety mechanisms including circuit breakers that halt automation when error rates exceed thresholds, canary deployment strategies for gradual rollout of scheduling changes, and rollback mechanisms using resource state snapshots stored in distributed consensus systems like Apache Zookeeper. The implementation should include real-time monitoring dashboards built with technologies like Grafana and Prometheus, providing alerts through webhooks to external systems and maintaining comprehensive audit trails using blockchain-like immutable logging for compliance and forensic analysis.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed by United States patent:

1. A computer-implemented method for schedule recommendation in FinOps governance with a multi-cloud governance platform, the method comprising:
collecting, by a computing system, utilization data from a plurality of cloud resources across multiple cloud service providers through application programming interfaces, wherein the utilization data comprises CPU utilization metrics, memory utilization metrics, and network utilization metrics for each cloud resource of the plurality of cloud resources;
normalizing, by the computing system, the utilization data by executing data processing operations comprising removing duplicates, adding derived time-based columns comprising date, datetime, hour, and day of week, and filtering incomplete data sets to generate normalized utilization data;
analyzing, by the computing system, the normalized utilization data using predefined thresholds to generate utilization scores for each cloud resource, wherein the predefined thresholds comprise idle thresholds and high utilization thresholds, and wherein analyzing comprises executing scoring algorithms that assign numerical scores based on resource utilization relative to the predefined thresholds;
generating, by the computing system, schedule recommendations based on the utilization scores by executing machine learning algorithms that process historical utilization patterns to identify optimal stop and start times, wherein the schedule recommendations comprise hourly recommendations for stopping cloud resources during specific hours and weekly recommendations for stopping cloud resources during specific days of the week;
presenting, by the computing system, the schedule recommendations to a user interface for review and implementation by rendering visual displays of recommended scheduling actions and associated cost savings;
calculating, by the computing system, potential cost reductions by executing cost analysis algorithms that multiply resource pricing data with recommended downtime periods; and
automatically implementing, by the computing system, the schedule recommendations by transmitting stop and start commands through cloud service provider APIs to control the plurality of cloud resources according to the schedule recommendations, thereby achieving the calculated cost reductions.

2. The method of claim 1, wherein the predefined thresholds comprise: idle thresholds defined as CPU utilization less than 5% and network utilization less than 1 Mb/s; and
high utilization thresholds defined as CPU utilization greater than 80% and memory utilization greater than 75%, and wherein the scoring algorithms assign a score of 1 for utilization below idle thresholds, a score of 2 for utilization between idle and high thresholds, and a score of 3 for utilization above high thresholds.

3. The method of claim 1, wherein analyzing the normalized utilization data further comprises: calculating, by the computing system, an hourly score as an average score of all metrics for each cloud resource by executing mathematical averaging operations on collected metric values; and calculating, by the computing system, a day-of-week score as an average score for each cloud resource by day name by executing aggregation algorithms that group utilization data by calendar day.

4. The method of claim 1, wherein the machine learning algorithms comprise anomaly detection algorithms that identify deviations from normal utilization patterns of the plurality of cloud resources by comparing current utilization metrics against trained baseline models derived from historical utilization data.

5. The method of claim 1, wherein calculating potential cost reductions comprises:
retrieving, by the computing system, current pricing information from the multiple cloud service providers through pricing APIs; computing, by the computing system, downtime cost savings by multiplying hourly resource costs with recommended shutdown periods; and displaying, by the computing system, the calculated cost reductions in the user interface alongside the schedule recommendations as quantified monetary savings.

6. The method of claim 1, wherein collecting utilization data comprises: establishing, by the computing system, secure API connections with cloud monitoring services of the multiple cloud service providers; pulling, by the computing system, the utilization data from the cloud monitoring services at regular intervals using automated polling mechanisms; and storing, by the computing system, the utilization data in a time-series database at hourly granularity to enable pattern analysis by hour, day, week, and month.

7. The method of claim 1, further comprising: configuring, by the computing system, exclusion settings through a configuration interface to exclude specific cloud resources from the schedule recommendations based on resource tags, geographic regions, service types, or recommendation sources; and filtering, by the computing system, the plurality of cloud resources according to the exclusion settings before generating the schedule recommendations.

8. The method of claim 1, wherein automatically implementing the schedule recommendations comprises: scanning, by the computing system, resource metadata to identify cloud resources tagged for auto-remediation; executing, by the computing system, automated shutdown and startup operations for the identified cloud resources by transmitting control commands to cloud service provider management APIs without requiring user intervention; and logging, by the computing system, all automated actions in an audit trail database.

9. The method of claim 1, further comprising: executing, by the computing system, ranking algorithms that order the schedule recommendations based on calculated potential cost savings from highest to lowest or operational impact from lowest to highest; and
presenting, by the computing system, the ranked schedule recommendations in the user interface with priority indicators.

10. The method of claim 1, further comprising: generating, by the computing system, notification alerts regarding the schedule recommendations by executing notification algorithms that format and transmit messages through email servers or IT service management tool APIs; compiling, by the computing system, assessment reports comprising executive summary reports and detailed recommendation reports by executing report generation algorithms that aggregate scheduling data and cost optimization opportunities; and storing, by the computing system, the assessment reports in a database for historical tracking and compliance documentation.
